(19) United States
(12) Patent Application Publication
(10) Pub. No.: US 2022/0127468 A1
(43) Pub. Date: Apr. 28, 2022

(54) ANTI-CORROSIVE MATERIAL, WIRE WITH TERMINAL, AND WIRE HARNESS

(71) Applicant: Yazaki Corporation, Tokyo (JP)

(72) Inventors: Kazuki Mano, Shizuoka (JP); Kenji Osada, Shizuoka (JP)

(73) Assignee: Yazaki Corporation, Tokyo (JP)

(21) Appl. No.: 17/511,677

(22) Filed: Oct. 27, 2021

(30) Foreign Application Priority Data
Oct. 28, 2020 (JP) 2020-180514

(51) Int. Cl. C09D 5/08; C09D 175/14; H01B 7/28; H01R 4/70

(52) U.S. Cl. CPC C09D 5/08; C09D 175/14; H01B 1/02; H01R 4/70; H01B 7/2806

(57) ABSTRACT

An anti-corrosive material contains a ultraviolet curable resin including a polymerizable compound including at least one of a photopolymerizable (meth)acrylate monomer or a photopolymerizable (meth)acrylate oligomer. The polymerizable compound includes a combination of certain substances. The photopolymerizable (meth)acrylate oligomer contains a low molecular-weight (meth)acrylate oligomer. The polymerizable compound contains a certain cross linking density increasing agent. 35 to 100 parts by mass of the cross linking density increasing agent are contained for 100 parts by mass of the ultraviolet curable resin. The anti-corrosive material has a viscosity of 18,900 mPa·s or less, the viscosity being measured at 25° C. according to JIS Z8803.

### CROSS REFERENCE TO RELATED APPLICATION

The present application is based on, and claims priority from the prior Japanese Patent Application No. 2020-180514, filed on Oct. 28, 2020, the entire contents of which are incorporated herein by reference.

### TECHNICAL FIELD

The present disclosure relates to an anti-corrosive material, a wire with a terminal, and a wire harness.

### BACKGROUND

In recent years, use of aluminum in a coated wire constituting a wire harnesses has been increasing to reduce a weight of a vehicle and thus increase the fuel efficiency of the vehicle. A metal terminal to be connected to such a coated wire is usually formed of copper or a copper alloy having excellent electrical properties. However, when different materials are used for a conductor of the coated wire and the metal terminal, corrosion of a joint between the conductor and the metal terminal is easily caused. Thus, an anti-corrosive material is required to prevent corrosion of the joint.

Patent Literature 1 (Japanese Unexamined Patent Application Publication No. 2011-103266) discloses a coated wire with a terminal formed of an anti-corrosive material containing a thermoplastic polyamide resin as a main component, and having a tensile shear strength of 6 N/mm² or greater for a bundle of aluminum, an elongation rate of 100% or greater, and a moisture absorbing rate of 1.0% or less. A thermoplastic polyamide resin has a relatively long curing time, and hence an attention has been paid to a ultraviolet curable resin that requires only a short-term curing processing. The ultraviolet curable resin is cured instantaneously through irradiation with ultraviolet light, and a washing step or a drying step is not required. Thus, subsequent steps can be performed immediately, and the process can be shortened. According to Patent Literature 1, the anti-corrosive material having high fluidity is applied to a joint part between a wire conductor and a metal terminal metal, thereby obtaining a coated wire including a sealing member obtained by curing the anti-corrosive material.

### SUMMARY

However, there arises a problem that the coated wire with a terminal disclosed in Patent Literature 1 is easily colored by a coloring agent contained in a long-life coolant (LLC) when being brought into contact with the LLC.

The present disclosure has been achieved in view of the above-mentioned problem in such a related-art. The present disclosure has an object to provide an anti-corrosive material for obtaining a sealing member that is hardly colored even after contact with an LLC, a wire with a terminal that is hardly colored even after contact with an LLC, and a wire harness including the wire with a terminal.

An anti-corrosive material according to an embodiment includes an ultraviolet curable resin including a polymerizable compound including at least one of a photopolymerizable (meth)acrylate monomer and a photopolymerizable (meth)acrylate oligomer, wherein the polymerizable compound includes a combination of a monofunctional (meth)acrylate monomer and a bifunctional (meth)acrylate monomer, or a combination of at least one of a monofunctional (meth)acrylate monomer or a bifunctional (meth)acrylate monomer and at least one of a trifunctional (meth)acrylate monomer or a polyfunctional (meth)acrylate monomer having four or more functional groups, the photopolymerizable (meth)acrylate oligomer contains a low molecular-weight (meth)acrylate oligomer having a weight-average molecular weight Mw of 1,000 or less, the polymerizable compound contains one or more kinds of cross linking density increasing agents selected from a group consisting of a bifunctional (meth)acrylate monomer, a trifunctional (meth)acrylate monomer, a polyfunctional (meth)acrylate monomer having four or more functional groups, and a low molecular-weight (meth)acrylate oligomer, 35 to 100 parts by mass of the one or more kinds of cross linking density increasing agents are contained for 100 parts by mass of the ultraviolet curable resin, and the anti-corrosive material has a viscosity of 18,900 mPa·s or less, the viscosity being measured at 25° C. according to JIS Z8803.

According to the above-mentioned configuration, there can be provided the anti-corrosive material for obtaining the sealing member that is hardly colored even after contact with an LLC, the wire with a terminal that is hardly colored even after contact with an LLC, and the wire harness including the wire with a terminal.

### BRIEF DESCRIPTION OF THE DRAWINGS

FIG. 1 is a schematic view illustrating a wire with a terminal according to the present embodiment.

FIG. 2 is a schematic view of a wire with a terminal according to the present embodiment for illustrating a state before the wire is connected to a metal terminal.

FIG. 3 is a schematic view of the wire with a terminal according to the present embodiment for illustrating a state in which the wire is connected to the metal terminal.

FIG. 4 is a schematic view of the wire with a terminal according to the present embodiment for illustrating a state in which an anti-corrosive material is applied to a joint between a metal terminal and a conductor and is cured.

FIG. 5 is a perspective view illustrating a wire harness according to the present embodiment.

### DETAILED DESCRIPTION

Various embodiments will be described hereinafter with reference to the accompanying drawings.

Now, with reference to the drawings, an anti-corrosive material, a wire with a terminal, and a wire harness according to the present embodiment are described. Note that dimensional ratios in the drawings are overdrawn for convenience of description, and may be different from actual dimensional ratios in some cases.

### [Anti-Corrosive Material]

The anti-corrosive material according to the present embodiment is cured to form a sealing member 30 that covers a joint 60 constituted of different metal parts, which is illustrated in FIG. 4. The sealing member 30 prevents corroding substances from entering the inside of the joint 60, and thus prevents corrosion of the joint 60 for a long time period. Further, the above-mentioned anti-corrosive material contains an ultraviolet curable resin.

Examples of the ultraviolet curable resin include a polymerizable compound including at least one of a photopolymerizable (meth)acrylate monomer or a photopolymerizable (meth)acrylate oligomer. Here, the photopolymerizable (meth)acrylate monomer and the photopolymerizable (meth)acrylate oligomer indicates a monomer and oligomer having a functional group having a carbon-carbon unsaturated bond, respectively. The ultraviolet curable resin at least contains a polymerizable compound, and contains a photopolymerization initiator and the like as required.

The ultraviolet curable resin preferably contains a polymerizable compound including a photopolymerizable (meth)acrylate monomer. Further, the ultraviolet curable resin preferably contains a polymerizable compound including both a photopolymerizable (meth)acrylate monomer and a photopolymerizable (meth)acrylate oligomer. When the anti-corrosive material containing the ultraviolet curable resin is used, a sealing member obtained by curing the resin has a high adhesive force, and has excellent weather resistance and impact resistance. Thus, when the anti-corrosive material containing the ultraviolet curable resin is used, corrosion of the joint can be prevented effectively.

(Photopolymerizable (meth)acrylate Monomer)

Usable photopolymerizable (meth)acrylate monomers constituting the polymerizable compound are a monofunctional (meth)acrylate monomer, a bifunctional (meth)acrylate monomer, a trifunctional (meth)acrylate monomer, and a polyfunctional (meth)acrylate monomer. Here, the monofunctional (meth)acrylate monomer is a (meth)acrylate monomer having one functional group having a carbon-carbon unsaturated bond. The bifunctional (meth)acrylate monomer is a (meth)acrylate monomer having two functional groups. The trifunctional (meth)acrylate monomer is a (meth)acrylate monomer having three functional groups. The polyfunctional (meth)acrylate monomer is a (meth)acrylate monomer having four or more functional groups. Note that, in the polymerizable compound constituting the anti-corrosive material according to the present embodiment, the above-mentioned photopolymerizable (meth)acrylate monomers are used in a certain combination. The certain combination of the photopolymerizable (meth)acrylate monomers is described later.

(Photopolymerizable (meth)acrylate Oligomer)

Usable photopolymerizable (meth)acrylate oligomers are a monofunctional (meth)acrylate oligomer, a bifunctional (meth)acrylate oligomer, a trifunctional (meth)acrylate oligomer, and a polyfunctional (meth)acrylate oligomer. Here, the monofunctional (meth)acrylate oligomer is a (meth)acrylate oligomer having one functional group having a carbon-carbon unsaturated bond. The bifunctional (meth)acrylate oligomer is a (meth)acrylate oligomer having two functional groups. The trifunctional (meth)acrylate oligomer is a (meth)acrylate oligomer having three functional groups. The polyfunctional (meth)acrylate oligomer is a (meth)acrylate oligomer having four or more functional groups.

Further, the photopolymerizable (meth)acrylate oligomer contains a low molecular-weight (meth)acrylate oligomer. Here, the low molecular-weight (meth)acrylate oligomer indicates a (meth)acrylate oligomer having a weight-average molecular weight Mw of 1,000 or less, preferably, 650 or less. Note that a (meth)acrylate oligomer having a weight-average molecular weight Mw greater than that of the low molecular-weight (meth)acrylate oligomer is also referred to as a high molecular-weight (meth)acrylate oligomer below.

Usable low molecular-weight (meth)acrylate oligomers are oligomers having the weight-average molecular weight Mw falling within the above-mentioned range, the oligomers being selected from the monofunctional (meth)acrylate oligomer, the bifunctional (meth)acrylate oligomer, the trifunctional (meth)acrylate oligomer, and the polyfunctional (meth)acrylate oligomer that are described above.

(Combination of Photopolymerizable (meth)acrylate Monomers)

Note that, when only at least one of a trifunctional (meth)acrylate monomer or a polyfunctional (meth)acrylate monomer is used as the monomer contained in the ultraviolet curable resin, a cross linking density of a cured object obtained from the ultraviolet curable resin tends to increase. The cured object obtained from the ultraviolet curable resin having an extremely high cross linking density has improved strength and hardness, and also has high surface curability (tackiness). However, the cured object has reduced elongation and depth curability, and the cured object to be obtained is likely to peel off For this reason, a sealing member using the cured object obtained from the ultraviolet curable resin having an extremely high cross linking density makes it difficult to prevent corrosion for a long time period.

Thus, the photopolymerizable (meth)acrylate monomers constituting the polymerizable compound used in the present embodiment are the plurality of kinds of the (meth)acrylate monomers used in a certain combination. Specifically, the polymerizable compound used in the present embodiment contains a first combination or a second combination of the plurality kinds of the (meth)acrylate monomers. The first combination is a combination of the monofunctional (meth)acrylate monomer and the bifunctional (meth)acrylate monomer. The second combination is a combination of at least one of the monofunctional (meth)acrylate monomer or the bifunctional (meth)acrylate monomer and at least one of the trifunctional (meth)acrylate monomer or the polyfunctional (meth)acrylate monomer having four or more functional groups.

In the first combination and the second combination, a (meth)acrylate compound having a small number of functional groups and a (meth)acrylate compound having a large number of functional groups are mixed instead of using only a polyfunctional (meth)acrylate monomer having three or more functional groups. With this, in the sealing member according to the present embodiment, the cross linking density of the cured object obtained from the ultraviolet curable resin can be prevented from increasing excessively. For this reason, the sealing member according to the present embodiment can have improved elongation and depth curability in addition to strength, hardness, and surface curability. As a result, the sealing member can be prevented from peeling off at the joint formed of different materials, and can prevent corrosion of the joint for a long time period. Here, depth curability is an index indicating a depth at which the resin is cured when being irradiated with light from above. Further, throughout the specification, the term “(meth)acrylate” includes both acrylate and methacrylate.

### (Cross Linking Density Increasing Agent)

The polymerizable compound contains a cross linking density increasing agent being a substance for improving a cross linking density of the ultraviolet curable resin, the cross linking density increasing agent being selected from the photopolymerizable (meth)acrylate monomers and the photopolymerizable (meth)acrylate oligomers that are described above. One or more kinds of substances selected from a group consisting of the bifunctional (meth)acrylate monomer, the trifunctional (meth)acrylate monomer, the polyfunctional (meth)acrylate monomer having four or more functional groups, and the low molecular-weight (meth)acrylate oligomer are used as the cross linking density increasing agents. When the polymerizable compound contains the cross linking density increasing agent, the cured object obtained from the ultraviolet curable resin having a high cross linking density is easily achieved.

35 to 100 parts by mass, preferably, 45 to 60 parts by mass of the cross linking density increasing agent are contained for 100 parts by mass of the ultraviolet curable resin. When the cross linking density increasing agent contained in the ultraviolet curable resin falls within the above-mentioned range, the cured object obtained from the ultraviolet curable resin having a high cross linking density is easily achieved.

The photopolymerizable (meth)acrylate monomer and the photopolymerizable (meth)acrylate oligomer are specifically described below.

### (Monofunctional Acrylate Monomer)

Usable monofunctional acrylate monomers are compounds represented by Chemical Formula 1. Specific examples thereof include ethoxylated o-phenylphenol acrylate (see Formula (a), viscosity: 150 mPa·s at a temperature of 25° C.), methoxypolyethylene glycol 400 acrylate (see Formula (b), where n=9, viscosity: 28 mPa·s at a temperature of 25° C.), methoxypolyethylene glycol 550 acrylate (see Formula (b), where n=13), phenoxypolyethylene glycol acrylate (see Formula (c), viscosity: 16 mPa·s at a temperature of 25° C.), 2-acryloyloxyethyl succinate (see Formula (d), viscosity: 180 mPa·s at a temperature of 25° C.), and isostearyl acrylate (see Formula (e), viscosity: 18 mPa·s at a temperature of 25° C.) produced by Shin Nakamura Chemical Co., Ltd. Further, other examples of the monofunctional acrylate monomer include β-carboxyethyl acrylate (viscosity: 75 mPa·s at a temperature of 25° C.), isobornyl acrylate (viscosity: 9.5 mPa·s at a temperature of 25° C.), octyl/decyl acrylate (viscosity: 3 mPa·s at a temperature of 25° C.), ethoxylated phenyl acrylate (EO: 2 mol) (viscosity: 20 mPa·s at a temperature of 25° C.), and ethoxylated phenyl acrylate (EO: 1 mol) (viscosity: 10 mPa·s at a temperature of 25° C.) produced by DAICEL-ALLNEX LTD.

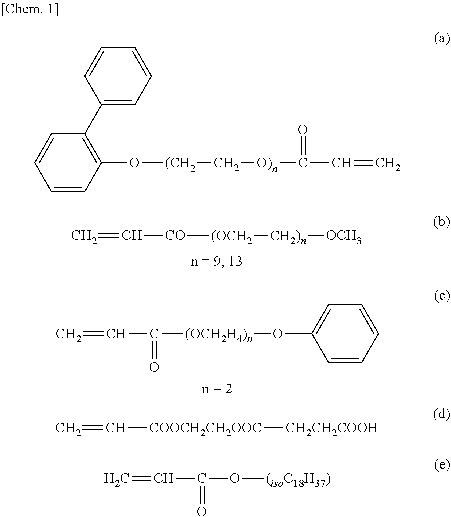

### (Bifunctional Acrylate Monomer)

Usable bifunctional acrylate monomers are compounds represented by Chemical Formula 2-1 to Chemical Formula 2-3. Specific example thereof include 2-hydroxy-3-(acryloyloxy)propyl methacrylate (see Formula (a), viscosity: 44 mPa·s at a temperature of 25° C.), polyethylene glycol 200 diacrylate (see Formula (b), n=4, viscosity: 22 mPa·s at a temperature of 25° C.), polyethylene glycol 400 diacrylate (see Formula (b), n=9, viscosity: 58 mPa·s at a temperature of 25° C.), polyethylene glycol 600 diacrylate (see Formula (b), n=14, viscosity: 106 mPa·s at a temperature of 25° C.), polyethylene glycol 1000 diacrylate (see Formula (b), n=23, viscosity: 100 mPa·s at a temperature of 40° C.), propoxylated ethoxylated bisphenol A diacrylate (see Formula (c), viscosity: 500 mPa·s at a temperature of 25° C.), ethoxylated bisphenol A diacrylate (see Formula (d), viscosity: 1500 mPa·s at a temperature of 25° C.), 9,9-bis[4-(2-acryloyloxyethoxy)phenyl]fluorene (see Formula (e), viscosity: 91,000 mPa·s at a temperature of 60° C.), propoxylated bisphenol A diacrylate(see Formula (f), viscosity: 3000 mPa·s at a temperature of 25° C.), tricyclodecane dimethanol diacrylate (see Formula (g), viscosity: 120 mPa·s at a temperature of 25° C.), 1,10-decanediol diacrylate (see Formula (h), viscosity: 10 mPa·s at a temperature of 25° C.), 1,6-hexanediol diacrylate (see Formula (i), viscosity: 8 mPa·s at a temperature of 25° C.), 1,9-nonanediol diacrylate (see Formula (j), viscosity: 8 mPa·s at a temperature of 25° C.), dipropylene glycol diacrylate (see Formula (k), viscosity: 8 mPa·s at a temperature of 25° C.), tripropylene glycol diacrylate (see Formula (l), m+n=3, viscosity: 12 mPa·s at a temperature of 25° C.), polypropylene glycol 400 diacrylate (see Formula (l), m+n=7, viscosity: 34 mPa·s at a temperature of 25° C.), polypropylene glycol 700 diacrylate (see Formula (l), m+n=12, viscosity: 68 mPa·s at a temperature of 25° C.), and polytetramethylene glycol 650 diacrylate (see Formula (m), viscosity: 140 mPa·s at a temperature of 25° C.) produced by Shin Nakamura Chemical Co., Ltd. Further, other examples of the bifunctional acrylate monomer include dipropylene glycol diacrylate (viscosity: 10 mPa·s at a temperature of 25° C.), 1,6-hexanediol diacrylate (viscosity: 6.5 mPa·s at a temperature of 25° C.), tripropylene glycol diacrylate (viscosity: 12.5 mPa·s at a temperature of 25° C.), PO-modified neopentyl glycol diacrylate (viscosity: 20 mPa·s at a temperature of 25° C.), modified bisphenol A diacrylate (viscosity: 1100 mPa·s at a temperature of 25° C.), tricyclodecane dimethanol diacrylate (viscosity: 140 mPa·s at a temperature of 25° C.), PEG 400 diacrylate (viscosity: 60 mPa·s at a temperature of 25° C.), PEG 600 diacrylate (viscosity: 120 mPa·s at a temperature of 25° C.), and neopentyl glycol-hydroxypivalic acid ester diacrylate (viscosity: 25 mPa·s at a temperature of 25° C.) produced by DAICEL-ALLNEX LTD.

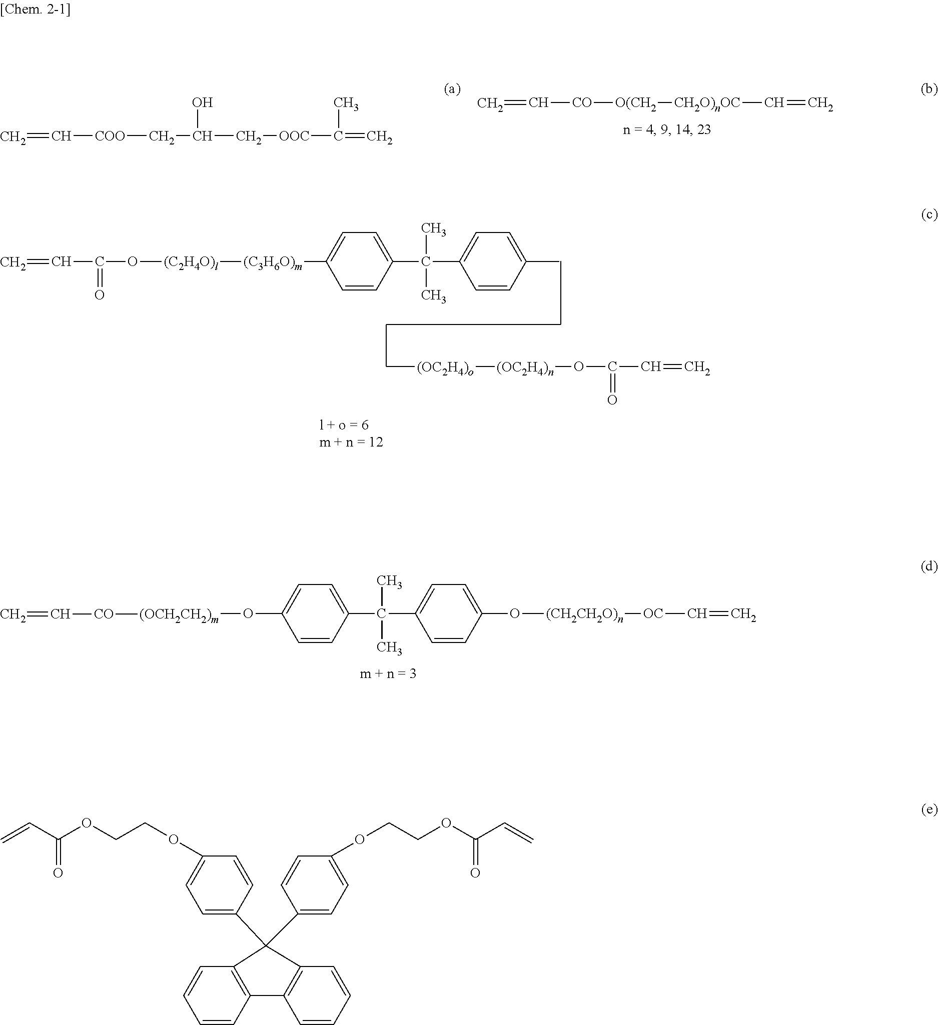

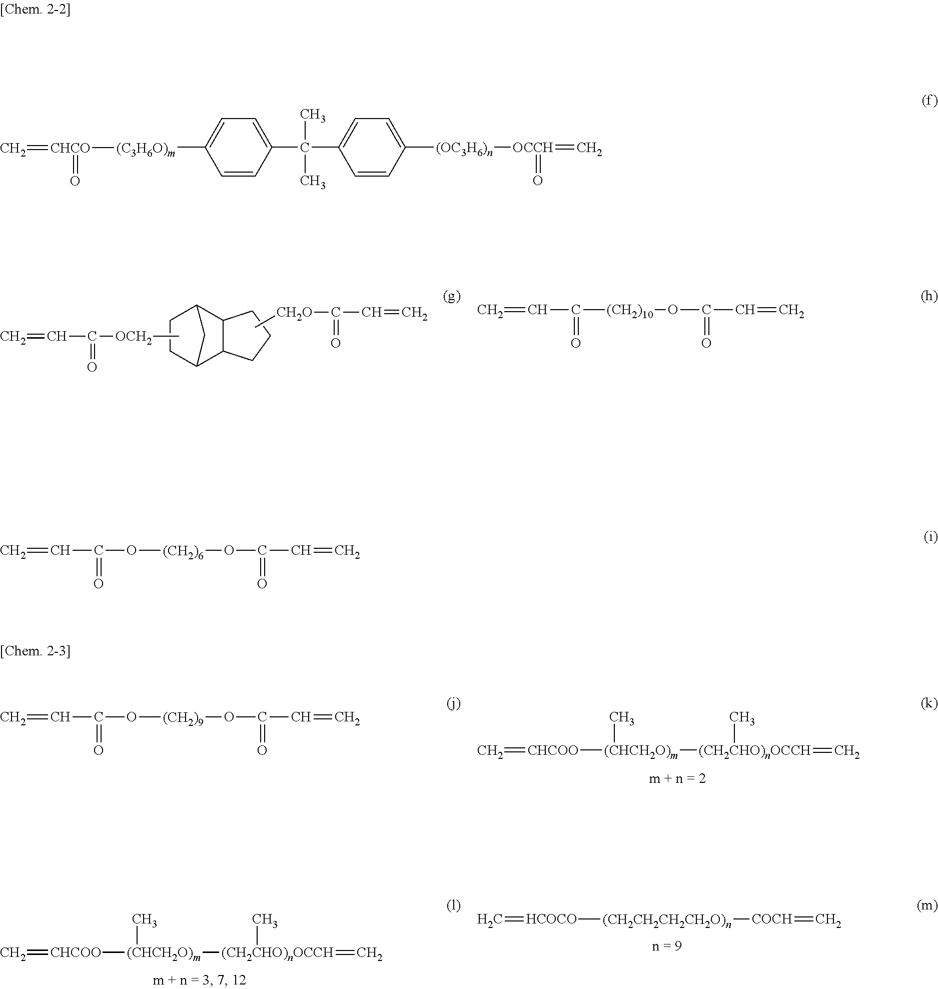

### (Trifunctional Acrylate Monomer and Polyfunctional Acrylate Monomer)

Usable trifunctional acrylate monomers and polyfunctional acrylate monomers are compounds represented by Chemical Formula 3-1 to Chemical Formula 3-2. Specific examples thereof include ethoxylated isocyanuric acid triacrylate (see Formula (a), viscosity: 1,000 mPa·s at a temperature of 50° C.), ε-caprolactone modified tris-(2-acryloxyethyl)isocyanurate (see Formula (b), viscosity: 3,000 to 4,000 mPa·s at a temperature of 25° C.), ethoxylated glycerine triacrylate (EO: 9 mol) (see Formula (c), l+m+n=9, viscosity: 190 mPa·s at a temperature of 25° C.), ethoxylated glycerine triacrylate (EO: 20 mol) (see Formula (c), l+m+n=20, viscosity: 110 mPa·s at a temperature of 25° C.), pentaerythritol triacrylate (triester: 37%) (see Formula (d), viscosity: 790 mPa·s at a temperature of 25° C.), pentaerythritol triacrylate (triester: 55%) (see Formula (d), viscosity: 490 mPa·s at a temperature of 25° C.), pentaerythritol triacrylate (triester: 57%) (see Formula (d), viscosity: 730 mPa·s at a temperature of 25° C.), trimethylolpropane triacrylate (see Formula (e), viscosity: 110 mPa·s at a temperature of 25° C.), ditrimethylolpropane tetraacrylate (see Formula (f), viscosity: 1,000 mPa·s at a temperature of 25° C.), ethoxylated pentaerythritol tetraacrylate (see Formula (g), viscosity: 350 mPa·s at a temperature of 25° C.), pentaerythritol tetraacrylate (see Formula (h), viscosity: 200 mPa·s at a temperature of 40° C.), dipentaerythritol polyacrylate (see Formula (i), viscosity: 6,500 mPa·s at a temperature of 25° C.), and dipentaerythritol hexaacrylate (see Formula (j), viscosity: 6,600 mPa·s at a temperature of 25° C.) produced by Shin Nakamura Chemical Co., Ltd. Further, examples of the polyfunctional acrylate monomer include dipentaerythritol pentaacrylate, phthalic acid monohydroxyethylacrylate, and isocyanuric acid ethylene oxide modified-diacrylate.

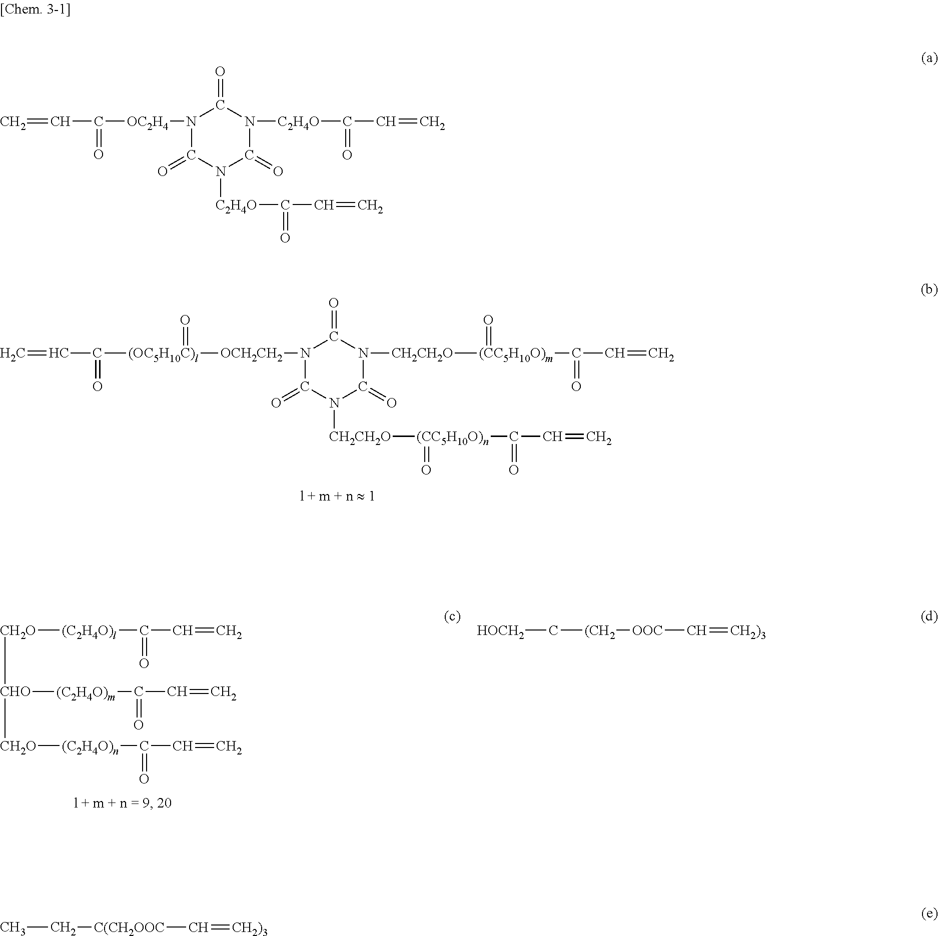

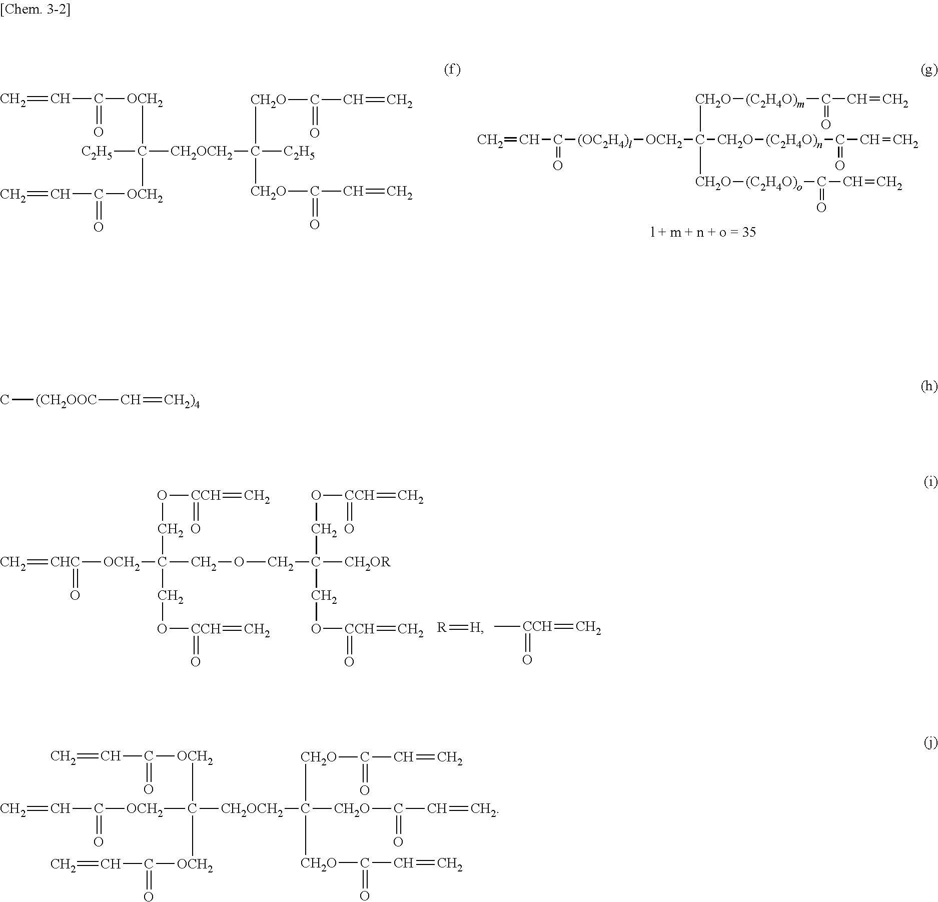

Other examples of the trifunctional acrylate monomer include pentaerythritol (tri/tetra) acrylate (viscosity: 1100 mPa·s at a temperature of 25° C.), trimethylolpropane triacrylate (viscosity: 100 mPa·s at a temperature of 25° C.), trimethylolpropane ethoxytriacrylate (viscosity: 60 mPa·s at a temperature of 25° C.), trimethylolpropane propoxytriacrylate (viscosity: 90 mPa·s at a temperature of 25° C.), and glycerin propoxytriacrylate (viscosity: 100 mPa·s at a temperature of 25° C.) produced by DAICEL-ALLNEX LTD. Other examples of the polyfunctional acrylate monomer having four or more functional groups include pentaerythritol ethoxytetraacrylate (viscosity: 160 mPa·s at a temperature of 25° C.), ditrimethylolpropane tetraacrylate (viscosity: 1,000 mPa·s at a temperature of 25° C.), pentaerythritol (tri/tetra) acrylate (viscosity: 700 mPa·s at a temperature of 25° C.), and dipentaerythritol hexaacrylate (viscosity: 6,900 mPa·s at a temperature of 25° C.) produced by DAICEL-ALLNEX LTD.

### (Monofunctional Methacrylate Monomer)

Usable monofunctional methacrylate monomers are compounds represented by Chemical Formula 4. Specific examples thereof include 2-methacryloyloxyethyl phthalic acid (see Formula (a), viscosity: 3,400 mPa·s at a temperature of 25° C.), methoxy polyethylene glycol 400 methacrylate (see Formula (b), n=9, viscosity: 23 mPa·s at a temperature of 25° C.), methoxy polyethylene glycol 1000 methacrylate (see Formula (b), n=23, viscosity: 55 mPa·s at a temperature of 40° C.), phenoxy ethylene glycol methacrylate (see Formula (c), viscosity: 7 mPa·s at a temperature of 25° C.), stearyl methacrylate (see Formula (d), viscosity: 8 mPa·s at a temperature of 30° C.), and 2-methacryloyloxyethyl succinate (see Formula (e), viscosity: 160 mPa·s at a temperature of 25° C.) produced by Shin Nakamura Chemical Co., Ltd.

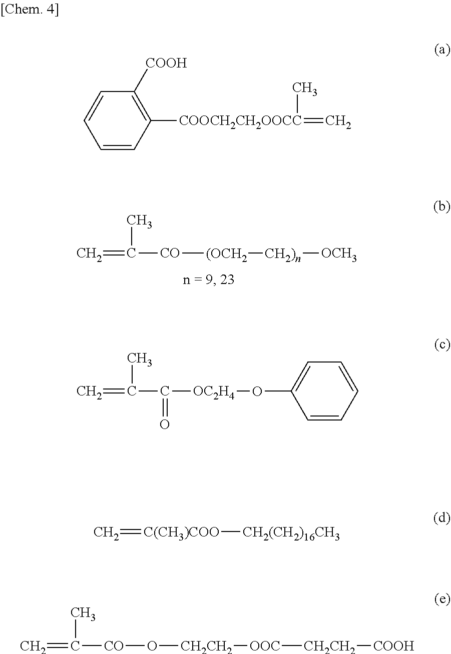

### (Bifunctional Methacrylate Monomer)

Usable bifunctional methacrylate monomers are compounds represented by Chemical Formula 5-1 and Chemical Formula 5-2. Specific examples thereof include ethylene glycol dimethacrylate (see Formula (a), viscosity: 3 mPa·s at a temperature of 25° C.), diethylene glycol dimethacrylate (see Formula (b), n=2, viscosity: 5 mPa·s at a temperature of 25° C.), triethylene glycol dimethacrylate (see Formula (b), n=3, viscosity: 9 mPa·s at a temperature of 25° C.), polyethylene glycol 200 dimethacrylate (see Formula (b), n=4, viscosity: 14 mPa·s at a temperature of 25° C.), polyethylene glycol 400 dimethacrylate (see Formula (b), n=9, viscosity: 35 mPa·s at a temperature of 25° C.), polyethylene glycol 600 dimethacrylate (see Formula (b), n=14, viscosity: 64 mPa·s at a temperature of 25° C.), polyethylene glycol 1000 dimethacrylate (see Formula (b), n=23, viscosity: 80 mPa·s at a temperature of 40° C.), ethoxylated bisphenol A dimethacrylate (see Formula (c), viscosity: 1000 mPa·s at a temperature of 25° C.), tricyclodecane dimethanol dimethacrylate (see Formula (d), viscosity: 100 mPa·s at a temperature of 25° C.), 1,10-decanediol dimethacrylate (see Formula (e), viscosity: 10 mPa·s at a temperature of 25° C.), 1,6-hexanediol dimethacrylate (see Formula (f), viscosity: 6 mPa·s at a temperature of 25° C.), 1,9-nonanediol dimethacrylate (see Formula (g), viscosity: 8 mPa·s at a temperature of 25° C.), neopentyl glycol dimethacrylate (see Formula (h), viscosity: 5 mPa·s at a temperature of 25° C.), ethoxylated polypropylene glycol 700 dimethacrylate (see Formula (i), viscosity: 90 mPa·s at a temperature of 25° C.), glycerin dimethacrylate (see Formula (j), viscosity: 40 mPa·s at a temperature of 25° C.), and polypropylene glycol 400 dimethacrylate (see Formula (k), viscosity: 27 mPa·s at a temperature of 25° C.) produced by Shin Nakamura Chemical Co., Ltd.

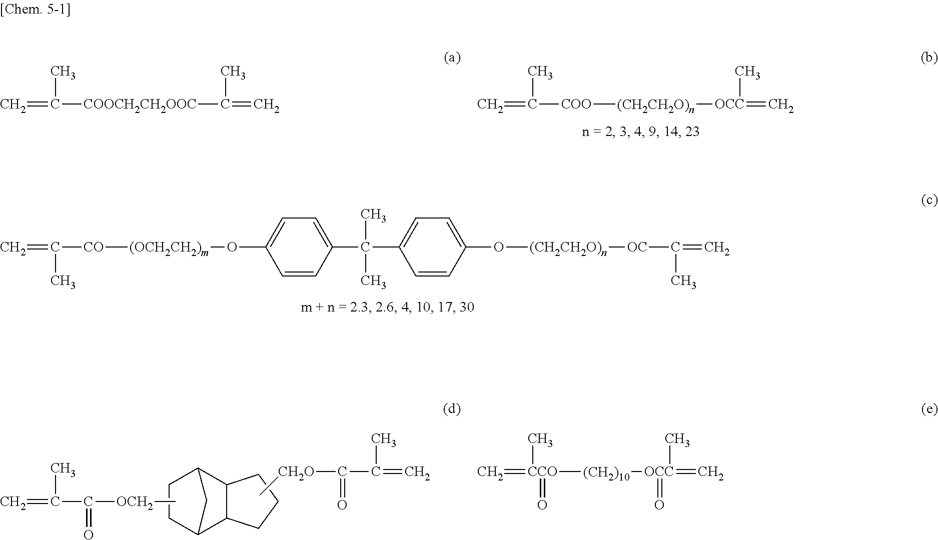

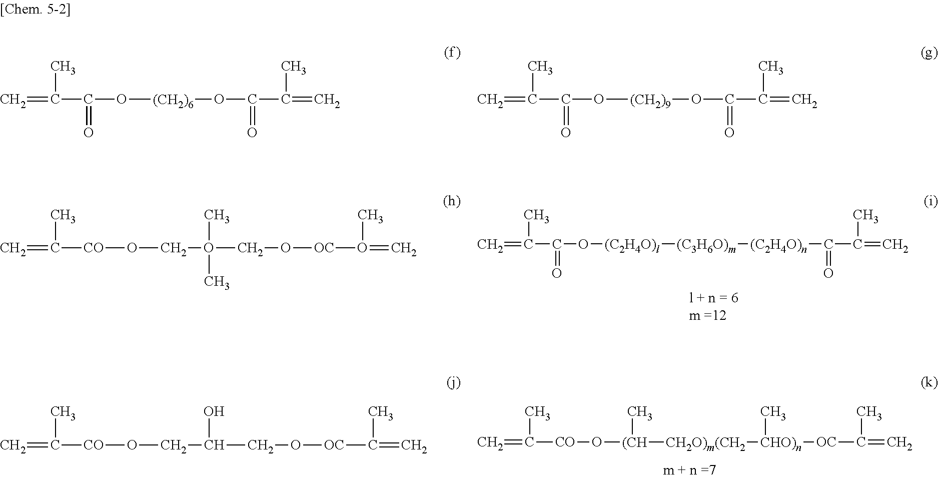

### (Trifunctional Methacrylate Monomer)

Usable trifunctional methacrylate monomers are compounds represented by Chemical Formula 6. Specific examples thereof include trimethylolpropane trimethacrylate (viscosity: 42 mPa·s at a temperature of 25° C.) produced by Shin Nakamura Chemical Co., Ltd.

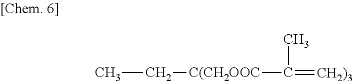

((meth)acrylate Oligomer)

Further, usable photopolymerizable (meth)acrylate oligomers are aromatic urethane acrylate, aliphatic urethane acrylate, polyester acrylate, and epoxy acrylate produced by DAICEL-ALLNEX LTD. Examples of the epoxy acrylate include bisphenol A epoxy acrylate, epoxyfied soybean oil acrylate, modified epoxy acrylate, fatty acid-modified epoxy acrylate, and amine-modified bisphenol A epoxy acrylate.

Examples of the photopolymerizable (meth)acrylate oligomer include acrylic acrylate such as polybasic acid-modified acrylic oligomer, and silicone acrylate.

(Low Molecular-Weight (meth)acrylate Oligomer)

A usable low molecular-weight (meth)acrylate oligomer is an aliphatic urethane acrylate produced by DAICEL-ALLNEX LTD. Specifically, aliphatic urethane acrylate EBECRYL® 8210 (average molecular weight Mw: 600) produced by DAICEL-ALLNEX LTD. may be used.

(High Molecular-Weight (meth)acrylate Oligomer)

A usable high molecular-weight (meth)acrylate oligomer is an aliphatic urethane acrylate produced by DAICEL-ALLNEX LTD. Specifically, aliphatic urethane acrylate EBECRYL® 4513 (average molecular weight Mw: 2,000) produced by DAICEL-ALLNEX LTD. may be used.

(Monofunctional (meth)acrylate Monomer)

Preferred monofunctional (meth)acrylate monomers are isobornyl acrylate and ethoxylated phenylacrylate. Preferred bifunctional (meth)acrylate monomers are 2-hydroxy-3-(acryloyloxy)propyl methacrylate and dipropylene glycol diacrylate. Preferred trifunctional (meth)acrylate monomers are glycerin propoxytriacrylate and trimethylolpropane propoxytriacrylate. Preferred polyfunctional (meth)acrylate monomers having four or more functional groups are pentaerythritol ethoxytetraacrylate and ditrimethylolpropane tetraacrylate. Note that, in the polymerizable compound of the present embodiment, a mixing ratio of the monofunctional (meth)acrylate monomer, the bifunctional (meth)acrylate monomer, the trifunctional (meth)acrylate monomer, and the polyfunctional (meth)acrylate monomer having four or more functional groups is not limited to Reference Examples and Examples described later, and may be set in a freely-selective manner so as to obtain effects of the present embodiment.

The ultraviolet curable resin according to the present embodiment preferably contains a photopolymerization initiator for accelerating ultraviolet light curing, in addition to the above-mentioned polymerizable compound. The photopolymerization initiator is a compound that initiates a polymerization reaction of the photopolymerizable monomer or the photopolymerizable oligomer. The photopolymerization initiator is a substance that absorbs a light component having a specific wavelength from ultraviolet light, is excited, and then generates radicals.

For example, at least one kind selected from a group consisting of a benzoin ether-based photopolymerization initiator, a ketal-based photopolymerization initiator, an acetophenone-based photopolymerization initiator, a benzophenone-based photopolymerization initiator, and a thioxanthone-based photopolymerization initiator may be used as the photopolymerization initiator. Note that those photopolymerization initiators are merely examples, and the present embodiment is not limited thereto. Specifically, various kinds of photopolymerization initiators may be used in accordance with purposes.

The ultraviolet curable resin according to the present embodiment contains the above-mentioned polymerizable compound as a main component. Further, the ultraviolet curable resin according to the present embodiment may contain other monomers and oligomers in addition to the above-mentioned polymerizable compound. Moreover, the ultraviolet curable resin may contain at least one of the additives listed below. Usable additives include photopolymerization initiating assistant agents, anti-adhesive agents, fillers, plasticizers, non-reactive polymers, coloring agents, flame retardants, flame retardant assistant agents, anti-softening agents, mold release agents, desiccants, dispersants, wetting agents, anti-settling agents, thickeners, anti-electrification agents, antistatic agents, matting agents, antiblocking agents, anti-skinning agents, and surfactants.

As described above, the anti-corrosive material according to the present embodiment contains the above-mentioned ultraviolet curable resin. For this reason, the anti-corrosive material is cured instantaneously through irradiation with ultraviolet light, and a washing step or a drying step is not required. Thus, subsequent steps can be performed immediately, and the process can be shortened. Note that, in a case where the viscosity of the ultraviolet curable resin is excessively high, when the anti-corrosive material containing the ultraviolet curable resin is applied to the joint 60, the application thickness is excessively increased. As a result, the thickness of the coating (sealing member) that is obtained through curing is increased. For this reason, when the metal terminal of the wire with a terminal 1 is accommodated in a connector housing, the sealing member cannot be inserted into a cavity of the connector housing. With this, there may be a risk that an existing connector housing cannot be used.

In view of this, the anti-corrosive material according to the present embodiment has a viscosity of 18,900 mPa·s or less, the viscosity being measured at 25° C. according to JIS Z8803 (the method of measuring a viscosity of a liquid). For this reason, the application thickness can be prevented from being excessively increased, and the thickness of the coating (sealing member) that is obtained through curing is not increased. Thus, an existing connector housing can be used. Note that the minimum value of the viscosity of the anti-corrosive material is not particularly limited, and may be set to 300 mPa·s, for example. When the viscosity of the anti-corrosive material is equal to or greater than this value, dripping at the time of applying the anti-corrosive material to the joint 60 is suppressed. Thus, the thickness of the coating that is obtained through curing can be substantially even, and anti-corrosive performance can be improved.

Note that the viscosity of the anti-corrosive material changes depending on a viscosity of each of the photopolymerizable (meth)acrylate monomer and the photopolymerizable (meth)acrylate oligomer, and an added amount of each of the monomer and the oligomer. Further, unless the polymerizable compound is irradiated with ultraviolet light to advance a polymerization reaction, the monomers, and the monomers and the oligomers are not polymerized to increase the viscosity of the polymerizable compound. For this reason, the viscosity of the anti-corrosive material, which is obtained by adjusting the viscosity and the added amount of each of the monomer and the oligomer, can be set to 18,900 mPa·s or less.

As described above, the anti-corrosive material according to the present embodiment includes an ultraviolet curable resin including a polymerizable compound including at least one of a photopolymerizable (meth)acrylate monomer or a photopolymerizable (meth)acrylate oligomer. The polymerizable compound includes a combination of a monofunctional (meth)acrylate monomer and a bifunctional (meth)acrylate monomer, or a combination of at least one of a monofunctional (meth)acrylate monomer or a bifunctional (meth)acrylate monomer and at least one of a trifunctional (meth)acrylate monomer or a polyfunctional (meth)acrylate monomer having four or more functional groups. The anti-corrosive material has a viscosity of 18,900 mPa·s or less, the viscosity being measured at 25° C. according to JIS Z8803.

In the present embodiment, the ultraviolet curable resin in which the (meth)acrylate monomer having a small number of functional groups and the (meth)acrylate monomer having a large number of functional groups are mixed is used as the anti-corrosive material. For this reason, the cured object to be obtained has an appropriate cross linking density, and hence can have improved elongation in addition to strength, hardness, and surface curability. Further, when the monomer contained in the ultraviolet curable resin is constituted of only a polyfunctional (meth)acrylate monomer having three or more functional groups, depth curability is reduced, the resin in the anti-corrosive material is not sufficiently cured and peels off from the joint, and anti-corrosive performance is reduced in some cases. However, in the present embodiment, the ultraviolet curable resin contains a (meth)acrylate compound having a small number of functional groups. Thus, reduction of depth curability can be suppressed, peeling can be prevented, and anti-corrosive performance can be improved.

Further, the anti-corrosive material has a viscosity that is equal to or lower than a predetermined value. Thus, the application thickness is prevented from being excessively increased, and increase in thickness of the coating that is obtained through curing can be prevented. Moreover, the anti-corrosive material is cured instantaneously through irradiation with ultraviolet light, and a washing step or a drying step is not required. Thus, the process can be shortened. Further, in the present embodiment, the anti-corrosive material in a liquid form is applied to the joint 60, and is irradiated with ultraviolet light and cured. Thus, when the wire and the joint 60 have any shapes, a sealing member excellent in anti-corrosive performance can be formed.

### (Effects of Disclosure)

With the anti-corrosive material according to the present embodiment, there can be provided the anti-corrosive material for obtaining the wire with a terminal that is hardly colored even after contact with an LLC.

### [Wire With Terminal]

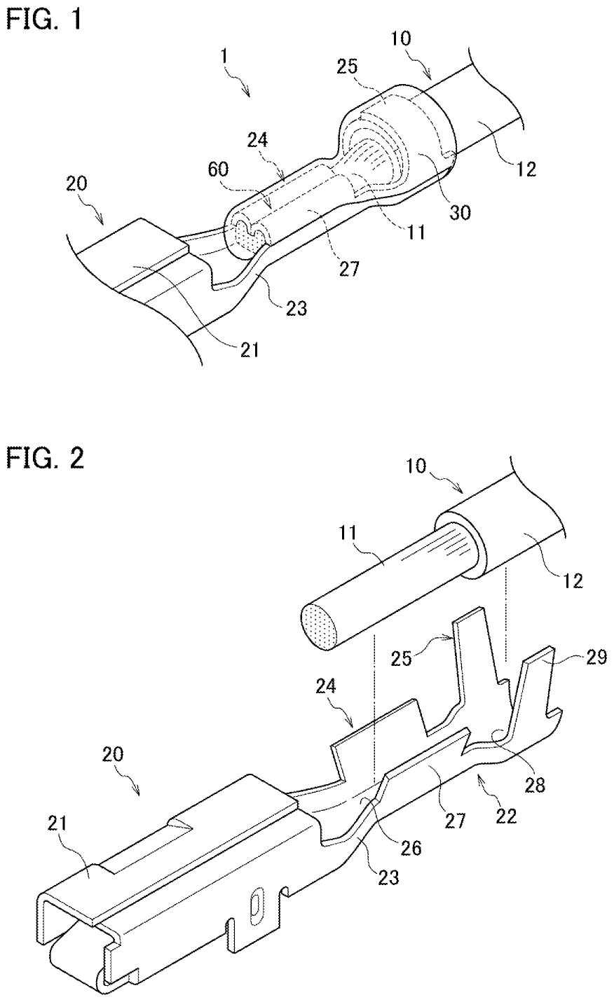

Next, a wire with a terminal according to the present embodiment is described. As illustrated in FIG. 1 to FIG. 4, a wire with a terminal 1 according to the present embodiment includes a wire 10 and a metal terminal 20. The wire 10 includes a conductor 11 having conductivity and a wire covering member 12 configured to cover the conductor 11. The metal terminal 20 is connected to the conductor 11 of the wire 10. Moreover, the wire with a terminal 1 includes a sealing member 30 configured to cover a joint 60 between the conductor 11 and the metal terminal 20, the sealing member 30 being formed by curing the above-mentioned anti-corrosive material.

The metal terminal 20 of the wire with a terminal 1 is a female type. The metal terminal 20 includes an electrical connection portion 21 at an end (not shown) thereof in the left part of FIG. 1. The electrical connection portion 21 is connected to a mating terminal (not shown). The electrical connection portion 21 has a box-like shape, and includes a built-in spring piece engageable with the mating terminal. Further, a wire connection portion 22 illustrated in FIG. 2 is provided to the electrical connection portion 21 in the right part of FIG. 1, through intermediation of a connection portion 23. The wire connection portion 22 is connected to the terminal portion of the wire 10 by crimping. When the wire connection portion 22 of the metal terminal 20 is connected to the terminal portion of the wire 10, a wire with a non-sealed terminal 5 is obtained. The wire with a non-sealed terminal 5 has the same configuration as that of the wire with a terminal 1 except that the sealing member 30 is not included.

The wire connection portion 22 is described in detail. The wire connection portion 22 includes a conductor press-fitting portion 24 positioned in the left part of FIG. 1 and a covering member crimping portion 25 positioned in the right part of FIG. 1.

The conductor press-fitting portion 24 is brought into direct contact with the conductor 11 that is exposed by removing the wire covering member 12 at the terminal portion of the wire 10, and includes a bottom plate portion 26 and a pair of conductor crimping pieces 27. The pair of conductor crimping pieces 27 are formed to extend upward in FIG. 2 from both lateral sides of the bottom plate portion 26. The pair of conductor crimping pieces 27 are bent inward so as to wrap the conductor 11 of the wire 10, thereby crimping the conductor 11 and the upper surface of the bottom plate portion 26 under a close contact state. With the bottom plate portion 26 and the pair of conductor crimping pieces 27, the conductor press-fitting portion 24 is formed to have a substantially U-like shape in a cross-sectional view.

Further, the covering member crimping portion 25 is brought into direct contact with the wire covering member 12 at the terminal portion of the wire 10, and includes a bottom plate portion 28 and a pair of covering member crimping pieces 29. The pair of covering member crimping pieces 29 extend upward in FIG. 2 from both lateral sides of the bottom plate portion 28, and are bent inward so as to wrap a part having the wire covering member 12, thereby crimping the wire covering member 12 and the upper surface of the bottom plate portion 28 under a close contact state. With the bottom plate portion 28 and the pair of covering member crimping pieces 29, the covering member crimping portion 25 is formed to have a substantially U-like shape in a cross-sectional view. Note that a common base plate portion is formed continuously from the bottom plate portion 26 of the conductor press-fitting portion 24 to the bottom plate portion 28 of the covering member crimping portion 25.

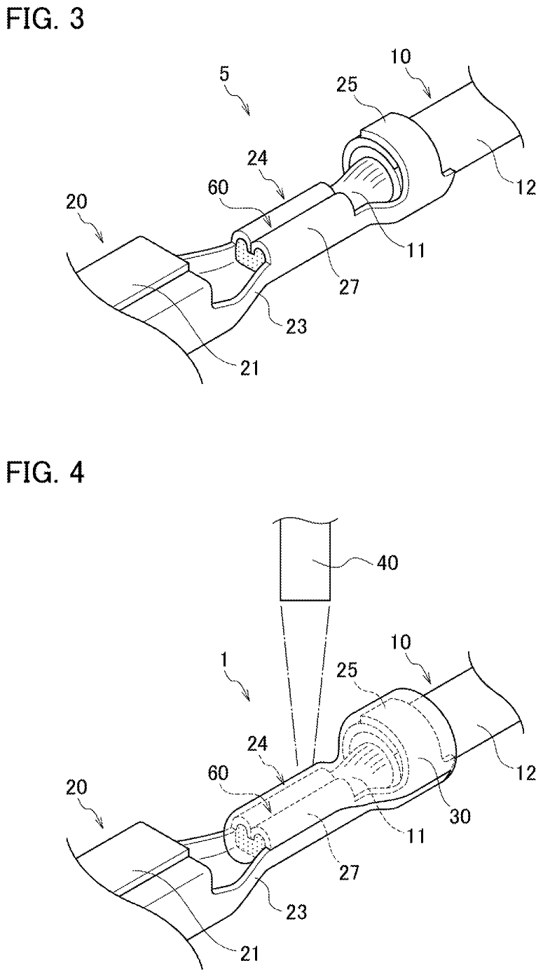

In the present embodiment, as illustrated in FIG. 2 and FIG. 3, the terminal portion of the wire 10 is inserted into the wire connection portion 22 of the metal terminal 20. With this, the conductor 11 of the wire 10 is placed on the upper surface of the bottom plate portion 26 of the conductor press-fitting portion 24 in FIG. 2. At the same time, the portion of the wire 10 with the wire covering member 12 is placed on the upper surface of the bottom plate portion 28 of the covering member crimping portion 25 in FIG. 2. After that, the wire connection portion 22 and the terminal portion of the wire 10 are pressed against each other, and thus the conductor press-fitting portion 24 and the covering member crimping portion 25 are deformed and subjected to crimping. Specifically, the pair of conductor crimping pieces 27 of the conductor press-fitting portion 24 are bent inward so as to wrap the conductor 11, thereby crimping the conductor 11 and the upper surface of the bottom plate portion 26 under a close contact state. Moreover, the pair of covering member crimping pieces 29 of the covering member crimping portion 25 are bent inward so as to wrap a part having the wire covering member 12, thereby crimping the wire covering member 12 under a close contact state with the upper surface of the bottom plate portion 28. With this, the metal terminal 20 and the wire 10 are connected to each other under a press-fitted state, and thus the wire with a non-sealed terminal 5 is obtained.

Further, as illustrated in FIG. 1 and FIG. 2, in the present embodiment, the sealing member 30 covers the connection portion 23, the wire connection portion 22, the conductor 11 and the upper part of the wire covering member 12 in FIG. 1, which are covered with the wire connection portion 22. Specifically, the sealing member 30 covers a part of the connection portion 23 over the boundary between the conductor press-fitting portion 24 and the distal end of the conductor 11 of the conductor 10, and the sealing member 30 covers and a part of the wire covering member 12 over the boundary between the covering member crimping portion 25 and the wire covering member 12. In the wire with a terminal 1, the sealing member 30 covers the conductor 11 and the upper part of the wire covering member 12, which are covered with the wire connection portion 22 as described above. Thus, corrosion of the joint 60 between the conductor 11 and the wire connection portion 22 can be suppressed.

The sealing member 30 is a cured object obtained by irradiating the anti-corrosive material containing the above-mentioned ultraviolet curable resin with ultraviolet light and curing the anti-corrosive material.

Metal having high conductivity may be used as a material of the conductor 11 of the wire 10. Usable materials include copper, a copper alloy, aluminum, and an aluminum alloy. Further, the surface of the conductor 11 may be subjected to tin plating. In recent years, reduction in weight of the wire harness has been demanded. In view of this, aluminum or an aluminum alloy having light weight is preferably used as the conductor 11. For this reason, the conductor 11 preferably includes an elemental wire formed of aluminum or an aluminum alloy.

A resin capable of securing an electric insulation property may be used as a material of the wire covering member 12 configured to cover the conductor 11. For example, a resin containing polyvinyl chloride (PVC) as a main component or an olefin-based resin may be used. Specific examples of the olefin-based resin include polyethylene (PE), polypropylene (PP), an ethylene copolymer, and a propylene copolymer.

Metal having high conductivity may be used as a material (terminal material) of the metal terminal 20. For example, at least one of copper, a copper alloy, stainless steel, copper subjected to tin plating, a copper alloy subjected to tin plating, or stainless steel subjected to tin plating may be used. Further, at least one of copper, a copper alloy, or stainless steel that are subjected to gold plating may be used. Alternatively, at least one of copper, a copper alloy, or stainless steel that are subjected to silver plating may be used. Note that the metal terminal preferably contains copper or a copper alloy.

Next, a method of manufacturing the wire with a terminal according to the present embodiment is described. As illustrated in FIG. 2 and FIG. 3, first, in the wire with a terminal 1, the terminal portion of the wire 10 is inserted into the wire connection portion 22 of the metal terminal 20. With this, the conductor 11 of the wire 10 is placed on the upper surface of the bottom plate portion 26 of the conductor press-fitting portion 24. At the same time, the portion of the wire 10 with the wire covering member 12 is placed on the upper surface of the bottom plate portion 28 of the covering member crimping portion 25. The pair of conductor crimping pieces 27 of the conductor press-fitting portion 24 are bent inward, thereby crimping the conductor 11 under a close contact state with the upper surface of the bottom plate portion 26. Moreover, the pair of covering member crimping pieces 29 of the covering member crimping portion 25 are bent inward, thereby crimping the wire covering member 12 under a close contact with the upper surface of the bottom plate portion 28. With this, the metal terminal 20 and the wire 10 can be connected to each other.

Subsequently, the anti-corrosive material is applied to the joint 60 between the metal terminal 20 and the wire 10. At this stage, the method of applying the anti-corrosive material is not particularly limited, and a coating machine of a dispenser type may be used, for example. As illustrated in FIG. 4, the anti-corrosive material is applied so as to cover the joint 60. Note that the anti-corrosive material preferably covers a part of the connection portion 23 over the boundary between the conductor press-fitting portion 24 and the distal end of the conductor 11 of the wire 10 and a part of the wire covering member 12 over the boundary between the covering member crimping portion 25 and the wire covering member 12 so as to secure high anti-corrosive performance.

Subsequently, the metal terminal 20 and the wire 10 to which the anti-corrosive material containing the ultraviolet curable resin is applied are irradiated with ultraviolet light through use of an ultraviolet light irradiation device 40. The ultraviolet light irradiation device 40 is a member that irradiates the anti-corrosive material with ultraviolet light for photocuring. For example, ultraviolet light having a wavelength from 10 nm to 400 nm is used as the light for photocuring the anti-corrosive material. One or more lamps selected from a mercury lamp, a high-pressure mercury lamp, an ultra high-pressure mercury lamp, a metal halide lamp, and an LED lamp may be used in combination as the ultraviolet light irradiation device 40. Among those examples, the LED lamp is preferred because a manufacturing apparatus 100 can be produced at a low cost. Note that the LED lamp has an emission wavelength being a single peak wavelength. Thus, photocuring performance may be degraded in some cases depending on a combination with the anti-corrosive material. In this case, a lamp other than the LED lamp may be used.

An irradiation amount and an irradiation time of ultraviolet light may be set appropriately in accordance with a type and an application amount of the ultraviolet curable resin contained in the anti-corrosive material. When the anti-corrosive material is irradiated with ultraviolet light through use of the ultraviolet light irradiation device 40, the anti-corrosive material can be cured instantaneously before the anti-corrosive material flows to change its shape. With this, the sealing member 30 is formed on the metal terminal 20 and the surface of the wire 10.

In general, the ultraviolet curable resin is known to cause reaction inhibition when being brought into contact with oxygen through curing. Specifically, oxygen in the air reacts with radicals generated by the photopolymerization initiator, and eliminates the radicals. With this, there may be a risk that a polymerization reaction of the ultraviolet curable resin is reduced and curing of the resin is not sufficiently promoted. For this reason, the ultraviolet curable resin that is less affected by the oxygen curing inhibition is preferably used as the anti-corrosive material used in the embodiment.

Further, a cooling step for cooling the sealing member 30 may be performed as required after the sealing member 30 is obtained through irradiation with ultraviolet light. Examples of the method of cooling the sealing member 30 include a cooling method in which air is sent and brought into contact with the sealing member 30, for example. It is preferred that the cooling step be performed in order to reduce a time required for curing.

As described above, the wire with a terminal according to the present embodiment includes the sealing member 30 obtained by curing the above-mentioned anti-corrosive material with ultraviolet light. The anti-corrosive material has a viscosity that is equal to or lower than a predetermined value. Thus, the application thickness is prevented from being excessively increased, and increase in thickness of the coating that is obtained through curing can be prevented. As a result, as described later, it is not required to change a pitch dimension of a connector housing. Thus, the wire with a terminal according to the present embodiment can be inserted into a connector housing having a conventional size. For this reason, it is not required to change design of a connector housing for the wire with a terminal according to the present embodiment.

### (Gelation Rate of Cured Object Obtained From Ultraviolet Curable Resin)

The cured object obtained from the ultraviolet curable resin forming the sealing member 30 has a gelation rate of 92% or greater, preferably, 92% to 96%, the gelation rate indicating a cross linking density. Here, the gelation rate is a value [%] obtained by dividing a mass Ma by a mass Mb. The mass Ma is a mass of the cured object obtained from the ultraviolet curable resin after immersed in acetone for 20 hours. The mass Mb is a mass of the cured object obtained from the ultraviolet curable resin before the immersion. When the gelation rate falls, within the above-mentioned range, a molecular weight of a cross linking point is reduced, and LCC is less absorbed, which is preferred.

### (Effects of Disclosure)

With the wire with a terminal according to the present embodiment, there can be provided the wire with a terminal that is hardly colored even after contact with an LLC.

### [Wire Harness]

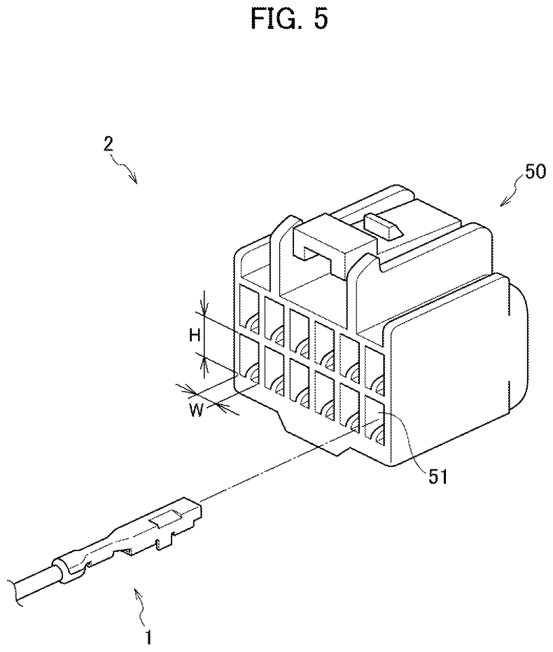

Next, a wire harness according to the present embodiment is described. The wire harness according to the present embodiment includes the above-mentioned wire with a terminal. Specifically, as illustrated in FIG. 5, a wire harness 2 includes a connector housing 50 and the above-mentioned wire with a terminal 1.

On a front surface side of the connector housing 50, a plurality of mating-side terminal mounting portions (not shown) to which mating terminals (not shown) are mounted are provided. On a back surface side of the connector housing 50, a plurality of cavities 51 are provided. Each of the cavities 51 has a substantially rectangular opening that allows the metal terminal 20 and the sealing member 30 of the wire with a terminal 1 to be mounted therein. Moreover, the opening of each of the cavities 51 is formed to be slightly larger than the cross-section of the metal terminal 20 and the sealing member 30. The metal terminal 20 is mounted to the connector housing 50, and the wire 10 is drawn out from the back surface side of the connector housing 50.

Here, as described above, the anti-corrosive material according to the present embodiment has a viscosity that is equal to or lower than a predetermined value. Thus, the application thickness is prevented from being excessively increased, and increase in thickness of the coating (sealing member) that is obtained through curing can be prevented. For this reason, the width of the sealing member of the wire with a terminal 1 can be set smaller than an opening width W of the cavity 51 of the connector housing 50 into which the metal terminal 20 and the sealing member 30 are inserted. Moreover, the maximum height of the anti-corrosive material of the wire with a terminal 1 can be set smaller than an opening height H of the cavity 51 of the connector housing 50.

As described above, the thickness of the sealing member 30 of the present embodiment can be reduced. Thus, it is not required to particularly change the pitch dimension of the connector housing 50. For this reason, the wire with a terminal can be inserted into a connector housing having a conventional size. Thus, it is not required to change design of a connector housing particularly for the wire with a terminal, and a conventional connector housing can be used.

### (Effects of Disclosure)

With the wire harness according to the present embodiment, there can be provided the wire harness including the wire with a terminal that is hardly colored even after contact with an LLC.

### EXAMPLES

The present embodiment is further described below in detail with Examples, Comparative Examples, and Reference Examples. However, the present embodiment is not limited to those examples.

The following compounds were used as oligomers, monomers, and a photopolymerization initiator when a wire with a terminal in each of the examples and comparative examples was produced.
Low molecular-weight oligomer: EBECRYL® 8210 (aliphatic urethane acrylate) produced by DAICEL-ALLNEX LTD., average molecular weight Mw: 600
High molecular-weight oligomer: EBECRYL® 4513 (aliphatic urethane acrylate) produced by DAICEL-ALLNEX LTD., average molecular weight Mw: 2,000
Monofunctional monomer: IBOA (isobornyl acrylate) produced by DAICEL-ALLNEX LTD.
Bifunctional monomer: TPGDA (tripropylene glycol diacrylate) produced by DAICEL-ALLNEX LTD.
Trifunctional monomer: PETRA (pentaerythritol triacrylate) produced by DAICEL-ALLNEX LTD.
Polyfunctional monomer: EBECRYL® 140 (ditrimethylolpropane tetraacrylate) produced by DAICEL-ALLNEX LTD.
Photopolymerization initiator: IRGACURE® 369 produced by BASF SE

Note that the low-molecular weight oligomer, the bifunctional monomer, the trifunctional monomer, and the polyfunctional monomer were cross linking density increasing agents.

### Example 1

First, the ultraviolet curable resin contained in the anti-corrosive material was prepared. Specifically, the monofunctional monomer, the bifunctional monomer, and the photopolymerization initiator were mixed in mass proportions of 80 parts by mass, 10 parts by mass, and 2 parts by mass, respectively, with respect to 100 parts by mass of the low molecular-weight oligomer. Table 1 shows composition rates of the ultraviolet curable resins.

Subsequently, aluminum was used as a conductor, and polyvinyl chloride (PVC) was used as a wire covering member to prepare a wire. Moreover, copper subjected to tin plating was used as a terminal material to prepare a metal terminal.

A wire with a terminal was prepared by connecting the wire and the metal terminal with each other, applying the anti-corrosive material to the joint 60 between the metal terminal and the wire, and curing the anti-corrosive material through use of a UV lamp.

### (Viscosity Measurement)

A viscosity of the anti-corrosive material was measured at a temperature of 25° C. according to JIS Z8803.

### (Evaluation on Anti-Corrosive Performance)

The anti-corrosive performance of the wire with a terminal was evaluated based on the measurement method specified in Japanese Industrial Standards JIS C60068-2-11 (Basic Environmental Testing Procedures Part 2: Tests-Test Ka: Salt mist). Specifically, the joint between the conductor and the metal terminal of the wire with a terminal was subjected to a salt mist test. More specifically, the test was performed under the following conditions: a temperature of 35±2° C., relative humidity (RH) of 85% or higher, a concentration of salt water of 5±1%, and the test period of 4 days. After that, whether corrosion (rust) was generated at the joint in each example was determined by visual observation. A case where corrosion was not confirmed was evaluated as “satisfactory”. Otherwise, an evaluation as “poor” was given.

### (Evaluation on Connector Housing Insertion Performance)

The wire with a terminal was inserted into a connector housing. Whether the sealing member was brought into contact with a circumferential wall of a cavity at the time of insertion into the connector housing was determined by visual observation. A case where the sealing member was not brought into contact with the circumferential wall of the cavity was evaluated as “satisfactory”. Otherwise, an evaluation as “poor” was given. Note that, in this evaluation, a wire ALVSS 2sq was used, and a connector housing 2.3II was used.

### (Evaluation on Gelation Rate)

The sealing member of the wire with a terminal was evaluated on its gelation rate. Specifically, a value [%] was obtained as a gelation rate by dividing the mass Ma by the mass Mb. The mass Ma was a mass of the sealing member (the cured object obtained from the ultraviolet curable resin) after immersed in acetone for 20 hours. The mass Mb was a mass of the sealing member before the immersion.

### (Evaluation on Color Change)

The wire with a terminal was immersed in LCC (LCC SUPER produced by CARTEC FUJI INCORPORATED.) for one hour, and color change of the sealing member before and after the immersion was observed. In Examples 2 to 4 and Comparative Examples 1 and 2, evaluation as “satisfactory” was given when color change was relatively small, and evaluation as “poor” was given when color change was relatively large.

The evaluation results are shown in Table 2.

TABLE 1

| | | | | | Example | Example | Example | Example | Comparative | Comparative |
|---|---|---|---|---|---|---|---|---|---|---|
| | | | Product name | Note | 1 | 2 | 3 | 4 | Example 1 | Example 2 |
| Ultraviolet | Polymerizable | Low molecular- | EBECRYL | Cross linking | 100 | 90 | 80 | 70 | — | — |
| curable | compound | weight oligomer | 8210 | density | | | | | | |
| resin | | (part by mass) | | increasing | | | | | | |
| | | | | agent | | | | | | |
| | | High molecular- | EBECRYL | | — | 10 | 20 | 30 | 100 | 100 |
| | | weight oligomer | 4513 | | | | | | | |
| | | (part by mass) | | | | | | | | |
| | | Monofunctional | IBOA | | 80 | 80 | 80 | 80 | 80 | — |
| | | monomer | | | | | | | | |
| | | (part by mass) | | | | | | | | |
| | | Bifunctional | TPGDA | Cross linking | 10 | 20 | — | 20 | — | 50 |
| | | monomer | | density | | | | | | |
| | | (part by mass) | | increasing | | | | | | |
| | | | | agent | | | | | | |
| | | Trifunctional | PETRA | Cross linking | — | — | 10 | — | — | — |
| | | monomer | | density | | | | | | |
| | | (part by mass) | | increasing | | | | | | |
| | | | | agent | | | | | | |
| | | Polyfunctionall | EBECRYL | Cross linking | — | — | — | 10 | — | — |
| | | monomer | 140 | density | | | | | | |
| | | (part by mass) | | increasing | | | | | | |
| | | | | agent | | | | | | |
| | | Total amount | | | 110 | 110 | 90 | 100 | 0 | 50 |
| | | of cross | | | | | | | | |
| | | linking density | | | | | | | | |
| | | increasing agent | | | | | | | | |
| | | (part by mass) | | | | | | | | |
| | | Total amount of | | | 190 | 200 | 190 | 200 | 180 | 150 |
| | | polymerizable | | | | | | | | |
| | | compound | | | | | | | | |
| | | (part by mass) | | | | | | | | |
| | | Composition | | | 57.9 | 55.0 | 47.4 | 50.0 | 0.0 | 33.3 |
| | | ratio of | | | | | | | | |
| | | Crosslinking | | | | | | | | |
| | | density improver | | | | | | | | |
| | | (mass %) | | | | | | | | |

| | | | | | | | |
|---|---|---|---|---|---|---|---|
| Photopolymerization initiator | IRUGACURE | 2 | 2 | 2 | 2 | 2 | 2 |
| (part by mass) | 369 | | | | | | |

| | | | | | | Comparative | Comparative |
|---|---|---|---|---|---|---|---|
| | | Example 1 | Example 2 | Example 3 | Example 4 | Example 1 | Example 2 |
| Evaluation | Gelation rate | 95 | 96 | 94 | 92 | 88 | 89 |
| | Color change | ○ | ○ | ○ | ○ | x | x |
| | | Satisfactory | Satisfactory | Satisfactory | Satisfactory | Poor | Poor |
| | Viscosity (mPa · s) | 300 | 2800 | 9600 | 2200 | 4300 | 18900 |
| | Connector insertion | ○ | ○ | ○ | ○ | ○ | ○ |
| | performance | Satisfactory | Satisfactory | Satisfactory | Satisfactory | Satisfactory | Satisfactory |
| | Anti-corrosive | ○ | ○ | ○ | ○ | ○ | ○ |
| | performance | Satisfactory | Satisfactory | Satisfactory | Satisfactory | Satisfactory | Satisfactory |

### Examples 2 to 4 and Comparative Examples 1 and 2

Each of the wire with a terminal was prepared in the same manner as in Example 1 except that the compounding rate of the ultraviolet curable resin contained in the anti-corrosive material was changed as shown in Table 1. The evaluation results are shown in Table 2.

As shown in Tables 1 and 2, the gelation rate was high, and color change was small in Examples 1 to 4 where the compounding rate of the cross linking density increasing agent was larger as compared to Comparative Examples 1 and 2 where the compounding ratio was small.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An anti-corrosive material comprising:
an ultraviolet curable resin comprising a polymerizable compound including at least one of a photopolymerizable (meth)acrylate monomer and a photopolymerizable (meth)acrylate oligomer, wherein
the polymerizable compound includes a combination of a monofunctional (meth)acrylate monomer and a bifunctional (meth)acrylate monomer, or a combination of at least one of a monofunctional (meth)acrylate monomer or a bifunctional (meth)acrylate monomer and at least one of a trifunctional (meth)acrylate monomer or a polyfunctional (meth)acrylate monomer having four or more functional groups,
the photopolymerizable (meth)acrylate oligomer contains a low molecular-weight (meth)acrylate oligomer having a weight-average molecular weight Mw of 1,000 or less,
the polymerizable compound contains one or more kinds of cross linking density increasing agents selected from a group consisting of a bifunctional (meth)acrylate monomer, a trifunctional (meth)acrylate monomer, a polyfunctional (meth)acrylate monomer having four or more functional groups, and a low molecular-weight (meth)acrylate oligomer,
35 to 100 parts by mass of the one or more kinds of cross linking density increasing agents are contained for 100 parts by mass of the ultraviolet curable resin, and
the anti-corrosive material has a viscosity of 18,900 mPa·s or less, the viscosity being measured at 25° C. according to JIS Z8803.

2. A wire with a terminal, comprising:
a wire including a conductor and a wire covering member configured to cover the conductor;
a metal terminal connected to the conductor of the wire; and
a sealing member configured to cover a joint between the conductor and the metal terminal, the sealing member being formed by curing the anti-corrosive material according to claim 1.

3. The wire with a terminal according to claim 2, wherein
a cured object obtained from the ultraviolet curable resin forming the sealing member has a gelation rate of 92% or greater, the gelation rate indicating a cross linking density.

4. The wire with a terminal according to claim 2, wherein
the conductor includes an elemental wire formed of aluminum or an aluminum alloy, and
the metal terminal contains copper or a copper alloy.

5. A wire harness comprising:
the wire with a terminal according to claim 2.
